(19) United States
(12) Patent Application Publication
(10) Pub. No.: US 2012/0106343 A1
(43) Pub. Date: May 3, 2012

(54) FLOW TRANSFER APPARATUS AND METHOD FOR TRANSFERRING FLOW BASED ON CHARACTERISTICS OF FLOW, TERMINAL APPARATUS AND FLOW PROCESSING METHOD

(75) Inventors: Seung-Woo LEE, Daejeon-si (KR); Bhum-Cheol LEE, Daejeon-si (KR)

(73) Assignee: Electronics and Telecommunications Research Institute, Daejeon-si (KR)

(21) Appl. No.: 13/286,697

(22) Filed: Nov. 1, 2011

(30) Foreign Application Priority Data
Nov. 1, 2010 (KR) 10-2010-0107799

(51) Int. Cl. H04W 28/10

(52) U.S. Cl. 370/235

(57) ABSTRACT

A flow transfer apparatus and method, which can make efficient use of limited resources in a wireless environment by dynamically mapping data flows to different transmission methods according to the characteristics of the flows, are provided. The flow transfer method includes analyzing an input packet stream to classify the input packet stream into a plurality of flows; dynamically determining a transmission method for each of the flows based on the characteristics of each of the flows; and transmitting the flows in parallel using their respective determined transmission methods.

### CROSS-REFERENCE TO RELATED APPLICATION(S)

This application claims the benefit under 35 U.S.C. §119(a) of Korean Patent Application No. 10-2010-0107799, filed on Nov. 1, 2010, in the Korean Intellectual Property Office, the entire disclosure of which is incorporated herein by reference for all purposes.

### BACKGROUND

1. Field

The following description relates to a flow transfer technique, and more particularly, to a flow transfer apparatus and method for effectively transferring a flow between devices equipped is with heterogeneous interfaces.

2. Description of the Related Art

Wireless mobile communication has become widespread with a variety of communication techniques. For example, various audio/data services are now being provided by wireless communication systems. Various multiplexing techniques such as time division multiplexing (TDM), frequency division multiplexing (FDM), code division multiplexing (CDM), and spatial division multiplexing (SDM), which can allow multiple users to share and effectively access limited wireless resources, have been developed. Thus, wireless mobile communication systems can provide various types of services such as Third Generation (3G), Wireless Fidelity (WiFi), and Wireless Broadband Internet (WiBro) services using the various multiplexing techniques.

Existing mobile communication systems transmit data to users through different networks to provide different services, such as 3G, WiFi, and WiBro services. 3G networks have a split network architecture with a circuit network and a packet network, and have evolved to enable all-layer transmission through internet protocol (IP) networks. WiFi networks can provide multiple access services, working with mobile networks, and can also provide various other application services such as Voice over Internet Protocol (VoIP), high-quality video, and Internet services.

In the meantime, various methods have been suggested to seamlessly provide services in a wireless environment with limited resources and to guarantee high Quality of Service (QoS) through a proper allocation of bandwidths. For example, a smart phone equipped with multiple interfaces can be provided with 3G or WiFi services using a dual mode for providing two or more interfaces. However, while being provided with data services from a 3G network, smart is phones cannot be provided with other data services or internet services from a WiFi network. Thus, smart phones can only be provided with services using one interface at a time. In addition, smart phone users are required to select a proper interface for the attributes of given data, thereby exacerbating the waste of wireless resources. Moreover, smart phone users are also required to select an interface manually according to the circumstances of the use of smart phones. In the case of a wired Ethernet, a maximum transmission speed for each interface is selected through negotiation. However, accessing a wired Ethernet at the maximum speed to receive periodic information such as weather information and gadget data that does not necessarily need to be transmitted at high speed often results in too much power consumption.

### SUMMARY

The following description relates to a flow transfer apparatus and method, which can make efficient use of limited resources in a wireless environment by dynamically mapping data flows to different transmission methods according to the characteristics of the data flows.

The following description also relates to a flow transfer apparatus and method, which can minimize power consumption by dynamically mapping data flows to different interface speeds according to the characteristics of the data flows, instead of automatically accessing a wired interface at a maximum speed.

In one general aspect, there is provided a flow transfer method including analyzing an input packet stream to classify the input packet stream into a plurality of flows; dynamically determining a transmission method for each of the flows based on the characteristics of each of the flows; and transmitting the flows in parallel using their respective determined transmission methods.

In another general aspect, there is provided a flow transfer apparatus including a flow is classification unit configured to analyze an input packet stream and thus to classify the input packet stream into a plurality of flows; a transmission method determination unit configured to dynamically determine a transmission method for each of the flows based on the characteristics of each of the flows; and a multiple wireless interface unit configured to transmit the flows in parallel using their respective determined transmission methods.

In another general aspect, there is provided a flow processing method including receiving a plurality of flows, via their respective transmission methods, from a flow transfer apparatus connected via a network, the transmission methods being dynamically determined based on the characteristics of the respective flows; and processing the received flows according to their characteristics.

In another general aspect, there is provided a terminal apparatus including a multiple wireless interface unit configured to receive a plurality of flows, via their respective transmission methods, from a flow transfer apparatus connected to the terminal apparatus via a network, the transmission methods being dynamically determined based on the characteristics of the respective flows; and a flow processing unit configured to process the received flows according to their characteristics.

Other features and aspects may be apparent from the following detailed description, the drawings, and the claims.

### BRIEF DESCRIPTION OF THE DRAWINGS

FIG. 1 is a diagram illustrating an example of a flow transfer system;

FIG. 2 is a diagram illustrating another example of a flow transfer system;

FIG. 3 is a diagram illustrating an example of a flow transfer apparatus;

FIG. 4 is a diagram illustrating an example of a terminal apparatus;

FIG. 5 is a flowchart illustrating an example of a flow transfer method;

FIG. 6 is a flowchart illustrating another example of a flow transfer method; and

FIG. 7 is a flowchart illustrating an example of a flow processing method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

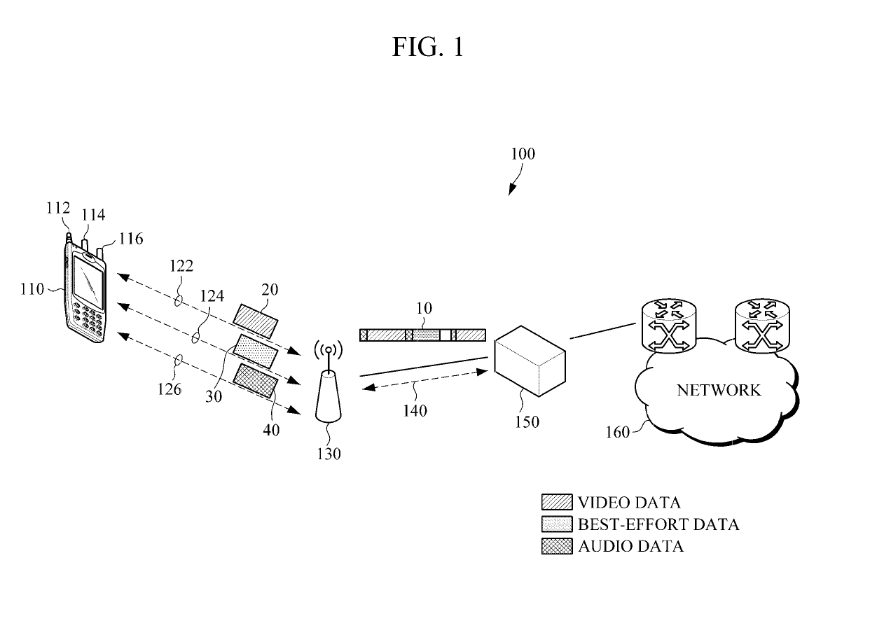

FIG. 1 illustrates an example of a flow transfer system. Referring to FIG. 1, a flow transfer system 100 may include a terminal apparatus 110, a wireless access point 130, a wireless access router 150, and a network 160.

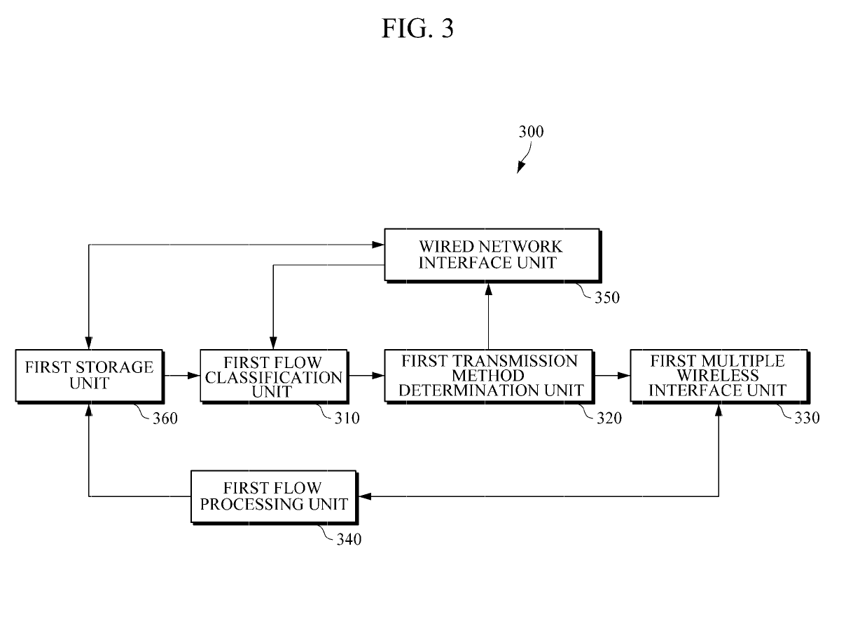

The terminal apparatus 110 and the wireless access point 130 are connected to a wireless network. The wireless access point 130 and the wireless access router 150 are connected to a wired network 140. The wireless access router 150 is connected to the network 160. The network 160 may include various types of networks such as a Service Provider's internet protocol (IP) network or a public IP network. The wireless access point 130 corresponds to an example of a flow transfer apparatus, which will be described later in detail with reference to is FIG. 3.

The terminal apparatus 110 may include multiple, heterogeneous wireless interfaces 112, 114, and 116. The terminal apparatus 110 may be implemented as various electronic products such as a personal computer, a laptop computer, a smart phone, a mobile phone, a personal digital assistant (PDA), a portable multimedia player (PMP), an MP3 player, or a digital camera. For example, the terminal apparatus 110 may be a laptop computer equipped with Wireless Fidelity (WiFi), Bluetooth, and Second and a Half Generation (2.5G)/Third Generation (3G) wireless interfaces. The wireless access point 130 may support multiple wireless interfaces.

Wireless interfaces are subject to limited wireless resources, and different types of wireless interfaces are likely to have different characteristics. A cell for a wireless communication between the terminal apparatus 110 and the wireless access point 130 is configured to be able to provide various wireless internet services such as 3G, Wireless Broadband Internet (WiBro) and WiFi services all together. Thus, the terminal apparatus 110 may transmit/receive data and control signals to/from the wireless access point 130 using existing wireless communication techniques, such as 3G, WiBro, and WiFi.

In the meantime, 3G can cover wide cell areas, can ensure high mobility, but is subject to limited bandwidths for the transmission of large amounts of data. WiFi can only cover small cell areas, cannot provide as high mobility as 3G, but can provide a large bandwidth for the transmission of large amounts of data. 3G was originally developed for systems for providing VoIP services, whereas WiFi was originally developed for systems for transmitting data from a wireless zone to another wireless zone at high speed. Thus, audio data may be transmitted between the wireless access point 130 and the terminal apparatus 110 via a 3G network, and best-effort data, which does not require high-speed, real time transmission, may be transmitted between the wireless access point 130 and the terminal apparatus 110 via a WiFi network.

As described above, it is possible to provide a high quality of service (QoS) by selecting a wireless channel that can ensure most excellent transmission properties for data of a packet stream based on the attributes of the data and transmitting the packet stream via the selected wireless channel. Therefore, it is possible to provide high-quality audio services via a 3G wireless interface that ensures a high QoS and to provide high-speed WiFi services that can allow a high-speed wireless transmission of data.

For this, the wireless access point 130 classifies an input packet stream provided by the wireless access router 150 into a plurality of flows 20, 30, and 40, and determines transmission methods 122, 124, and 126 for the flows 20, 30, and 40, respectively, based on the characteristics of the flows 20, 30, and 40. Then, the wireless access point 130 transfers the flows 20, 30, and 40 to the multiple wireless interfaces 112, 114, and 116 of the terminal apparatus 110 using the transmission methods 122, 124, and 125, respectively.

The term ‘flow,’ as used herein, indicates a group of packets sharing similar characteristics. A flow may include a data flow, which can be classified according to the type s of data included therein, and a control flow, which includes control information. The characteristics of a flow may include at least one of the attributes of data included in the flow and the attributes of a service provided using the flow. The attributes (or context) of data included in a flow may include video data, audio data, best-effort data, weather data, mail data, and gadget data. The attributes of a service provided using a flow may include an audio service, a video service, a file transfer service and a mail service.

The terminal apparatus 110 and the wireless access point 130 are assumed to use n interfaces. The wireless access point 130 may classify the input packet stream or input data into an audio data flow, a video data flow, and a best-effort data flow based on the attributes of the input packet stream or the input data.

In this case, the wireless access point 130 determines most suitable transmission methods for the flows 20, 30, and 40 based on the attributes of data included in each of the flows 20, 30, and 40 or the attributes of a service provided using each of the flows 20, 30, and 40, and transfers the flows 20, 30, and 40 to the terminal apparatus 110, which has the multiple interfaces 112, 114, and 116, via a wireless network by using the determined most suitable transmission methods for the flows 20, 30, and 40, i.e., the transmission methods 122, 124, and 126. The determined most suitable transmission methods for the flows 20, 30, and 40 may include transmission techniques such as time division multiplexing (TDM), frequency division multiplexing (FDM), orthogonal frequency division multiplexing (OFDM), code division multiplexing (CDM), or space division multiplexing (SDM) and service techniques such as WiFi, 3G, or WiBro. Therefore, the wireless access point 130 can efficiently transmit data to multiple subscribers even with limited frequency resources by using different transmission methods for different flows of a packet stream.

The terminal apparatus 110 may be configured to transfer a plurality of flows to the wireless access point 130 using the multiple wireless interfaces 112, 114, and 116 and using various transmission methods. The wireless access point 130 may classify and process the flows provided by the terminal apparatus 110 according to their information (such as context or service attributes). For example, the wireless access point 130 generates a packet stream to be processed by an IP network based on the flows provided by the terminal apparatus 110 via the transmission methods 122, 124, and 126, and transmits the generated packet stream to the wireless access router 150.

The wireless access point 130 and the wireless access router 150 may be connected to a wired Ethernet. The wireless access point 130 may transmit a packet stream provided by the wireless access router 150 to the terminal apparatus 110.

Even though the terminal apparatus 110 includes more than one wireless interface, i.e., the multiple wireless interfaces 112, 114, and 116, only one IP address may be allocated to the terminal apparatus 110. The terminal apparatus 110 may transmit or receive data using all the multiple wireless interfaces 112, 114, and 116 at the same time. In order to transmit a packet stream (or data) to the terminal apparatus 110 via the wireless access router 150 and the wireless access point 130, the packet stream may need to have a single IP address, i.e., the IP address of the terminal apparatus 110, as its destination address. Therefore, a packet stream transmitted from the wireless access router 150 to the wireless access point 130 may have a single IP address and may include a variety of attributes such as audio data, video data, and best-effort data.

In the example of FIG. 1, various transmission methods are dynamically mapped to data flows according to the context or service attributes of the data flows, thereby making efficient use of limited resources in a wireless environment. In addition, it is possible for a user to utilize the combined bandwidth of multiple interfaces. For example, when there are two interfaces, i.e., first and second interfaces I1 and I2 having first and second bandwidths B1 and B2, respectively, the user can utilize the combined bandwidth of the first and second interfaces, i.e., B1+B2.

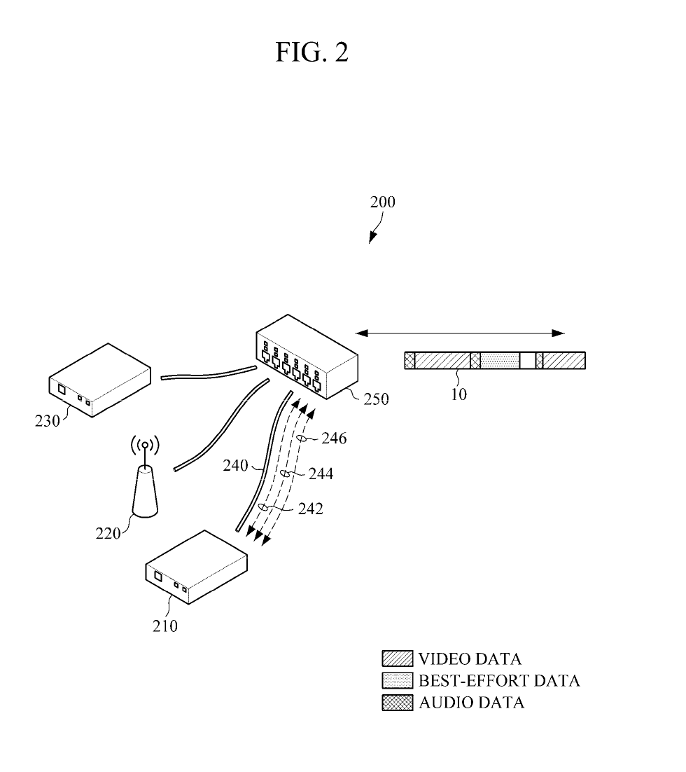

FIG. 2 illustrates another example of a flow transfer system. Referring to FIG. 2, a flow transfer system 200 may include a first terminal apparatus 210, a wired access point 220, a second terminal apparatus 230, and a flow transfer apparatus 250. The flow transfer apparatus 250 may be connected to the first terminal apparatus 210, the wired access point 220, and the second terminal apparatus 230 via a wired Ethernet 240. The flow transfer apparatus 250 may be implemented as a switch hub.

The wired Ethernet 240 may have a plurality of transmission channels 242, 244, and 246 that offer different transmission speeds. For example, the wired Ethernet 240 may provide 10 Mbps, 100 Mbps, and 1000 Mbps Ethernet interfaces to multiple users in order to provide various transmission speeds.

In a typical wired Ethernet, a maximum transmission speed is selected through negotiation based on the maximum speed of an interface. For example, when connected to a 10 Mbps interface, data can be transmitted at a maximum speed of 10 Mbps. When connected to a 1000 Mbps interface, data can be transmitted at a maximum speed of 1000 Mbps. However, if even data (such as weather data or gadget data) that does not necessarily need to be transmitted at high speed is transmitted at such maximum speed, too much power consumption may be incurred.

The flow transfer apparatus 250 may analyze information on a downlink packet stream, classifies the downlink packet stream into a number of flows based on the results of the analysis, determines a transmission speed for each of the flows, and transmits the flows at their respective determined transmission speeds. For example, the flow transfer apparatus 250 may classify a packet stream into an audio data flow, a weather data flow, a gadget flow, a video data flow, and a best-effort data flow and may determine a transmission speed for each of the audio data flow, the weather data flow, the gadget flow, the video data flow, and the best-effort data flow.

For example, if a 1G Ethernet interface is provided, the flow transfer apparatus 250 may transmit the classified data flows at the maximum speed of a 10 Mbps Ethernet interface, at the maximum speed of a 100 Mbps Ethernet interface, or at the maximum speed of a 1000 Mbps Ethernet interface.

The flow transfer apparatus 250 may receive a plurality of flows from 10 Mbps, 100 Mbps, and 1000 Mbps Ethernet interfaces, classify the received flows according to their transmission speeds, process the received flows according to their attributes (i.e., context or is service attributes), and transmit the processed flows to an uplink network node, e.g., the wired access point 220, as a packet stream.

In the example of FIG. 2, it is possible to minimize power consumption by dynamically mapping data flows to different interface speeds according to the context or service attributes of each of the data flows, instead of automatically accessing a wired interface at a maximum speed.

FIG. 3 illustrates an example of a flow transfer apparatus. Referring to FIG. 3, a flow transfer apparatus 300 may include a first flow classification unit 310, a first transmission method determination unit 320, a first multiple wireless interface unit 330, a first flow processing unit 340, a wired network interface unit 350 and a first storage unit 360. The flow transfer apparatus 300 may be configured to be a network access node such as the wireless access point 130 of FIG. 1.

The first flow classification unit 310 analyzes an input packet stream and classifies the input packet stream into a plurality of flows. The input packet stream may be a packet stream provided by an upper network access node (not shown) via the wired network interface unit 350 or may be a packet stream stored in the first storage unit 360.

The first flow classification unit 310 may classify the input packet stream into a plurality of flows, each flow sharing common attributes. For example, the first flow classification unit 310 may classify the input packet stream into a plurality of flows according to data context or service attributes, as described above with reference to FIG. 1.

The first transmission method determination unit 320 dynamically determines a transmission method for each of the flows of the input packet stream based on the characteristics of each of the flows of the input packet stream. For example, the first transmission method determination unit 320 may determine that audio data should be transmitted via 3G, and that is best-effort data that does not necessarily need to be transmitted in real time at high speed be transmitted via WiFi.

The first multiple wireless interface unit 330 may include a plurality of wireless interfaces, such as a 3G interface, a WiFi interface, a WiBro interface, and a Bluetooth interface.

The first multiple wireless interface unit 330 may transmit the flows of the input packet stream in parallel to a terminal apparatus (not shown) having the destination address of the input packet stream by using the transmission methods determined for the respective flows by the first transmission method determination unit 320.

When a plurality of flows are received in parallel from a terminal apparatus (not shown) connected to the flow transfer apparatus 300 via the first multiple wireless interface unit 330, the first flow processing unit 340 may generate a packet stream based on the received flows. The generated packet stream may be stored in the first storage unit 360.

The wired network interface unit 350 may be configured to communicate with a network access apparatus (not shown) or another flow transfer apparatus via a plurality of transmission channels with different transmission speeds. If the first transmission method determination unit 320 dynamically determines a transmission speed for each of a plurality of flows based on the characteristics of each of the flows, the wired network interface unit 350 may transmit the flows via transmission channels corresponding to their respective determined transmission speeds. For example, the wired network interface unit 350 may transmit a data flow such as gadget data or weather data that does not need to be transmitted at high speed to a terminal apparatus via a transmission channel that offers a low transmission speed.

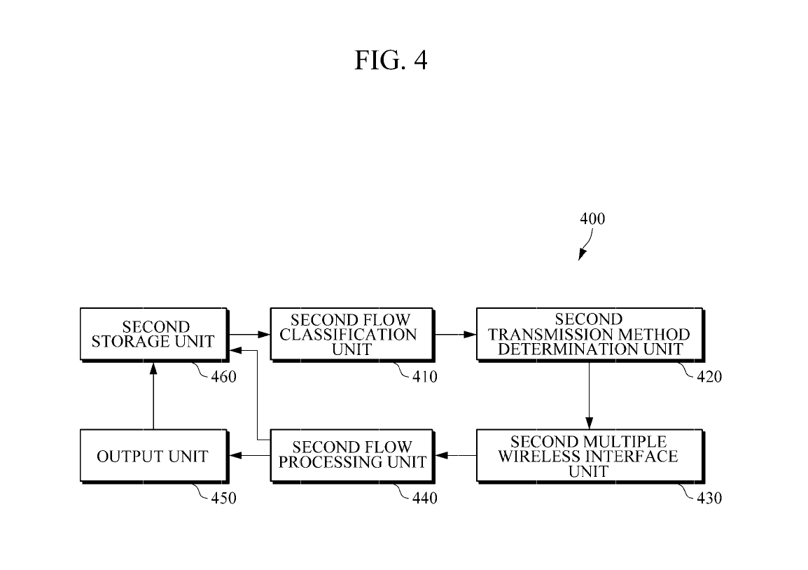

FIG. 4 illustrates an example of a terminal apparatus. Referring to FIG. 4, a terminal apparatus 400 may include a second flow classification unit 410, a second transmission method determination unit 420, a second multiple wireless interface unit 430, a second flow processing is unit 440, an output unit 450, and a second storage unit 460. The terminal apparatus 400 may process a plurality of flows provided by the flow transfer apparatus 300 shown in FIG. 3, and may output the processed flows or store the processed flows therein. The terminal apparatus 400, like the flow transfer apparatus 300, may be configured to dynamically determine a transmission method or speed for each of a plurality of flows and to transmit the flows using their respective determined transmission methods or speeds.

The second flow classification unit 410 analyzes an input packet stream and thus classifies the input packet stream into a plurality of flows. The operation of the second flow classification unit 410 is the same as the first flow classification unit 310 shown in FIG. 3. The input packet stream may be a packet stream provided by an external source or may be a packet stream (such as personal content) stored in the second storage unit 460.

The second transmission method determination unit 420 dynamically determines a transmission method for each of the classified flows of the input packet stream. The operation of the second transmission method determination unit 420 is the same as the operation of the first transmission method determination unit 320 shown in FIG. 3.

The second multiple wireless interface unit 430, like the first multiple wireless interface unit 330 shown in FIG. 3, may include a plurality of wireless interfaces. The second multiple wireless interface unit 430 may be configured to receive a plurality of flows in parallel via their respective transmission methods. The second multiple wireless interface unit 430 may transmit the classified flows to an external access network apparatus using their respective transmission methods determined by the second transmission method determination unit 420. The second multiple wireless interface unit 430 may be configured to have a common IP address for the terminal apparatus 400.

The second flow processing unit 440 processes a plurality of flows provided by the second multiple wireless interface unit 430 according to their characteristics. The second flow processing unit 440 may include a data processor such as a micro controller or a digital signal processor. The flows processed by the second flow processing unit 440 may be stored in the second storage unit 460.

The output unit 450 outputs the flows processed by the second flow processing unit 440. The output unit 450 may include various output devices such as a display or a speaker.

The terminal apparatus 400 may also include a wired network interface unit (not shown), which is configured to communicate with a network access apparatus (not shown) via a plurality of transmission channels that offer different transmission speeds. If the second transmission method determination unit 420 dynamically determines a transmission speed for each of a plurality of flows based on the characteristics of each of the flows, the wired network interface unit may transmit the flows using transmission channels corresponding to their respective determined transmission speeds. The terminal apparatus 400 may receive a plurality of flows from a flow transfer apparatus connected thereto via a wired Ethernet at the transmission speeds dynamically determined for the respective flows. In this case, the terminal apparatus 400 may classify and process the received flows according to their transmission speeds.

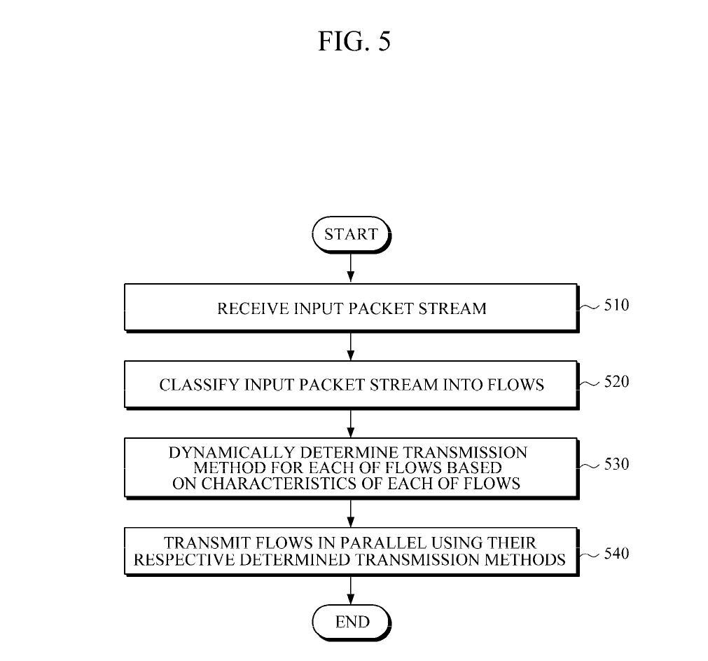

FIG. 5 illustrates an example of a flow transfer method. Referring to FIGS. 3 and 5, the flow transfer apparatus 300 receives an input packet stream from a network access apparatus (510).

The flow transfer apparatus 300 analyzes the input packet stream and thus classifies the input packet stream into a plurality of flows (520). For example, the flow transfer apparatus 300 may classify the input packet stream into a plurality of flows according to a predefined rule that determines how the flows should be transmitted, but the present invention is not restricted to this. That is, the flow transfer apparatus 300 may classify the input packet stream into a plurality of flows according to various rules, other than that set forth herein.

The flow transfer apparatus 300 dynamically determines a transmission method for each of the flows (530).

As described above, the characteristics of each of the flows may include at least one of the attributes of data included in each of the flows and the attributes of a service provided using each of the flows. The data attributes may include at least one of video data, audio data, best-effort data, weather data, mail data, and gadget data. The service attributes may include at least one of an audio service, a video service, a file transfer service, a mail service, and etc. The transmission methods determined in operation 530 may include at least one of TDM, FDM, OFDM, CDM, SDM, WiFi, 3G, and WiBro.

The flow transfer apparatus 300 transmits the flows in parallel using their respective transmission methods determined in operation 530 (540).

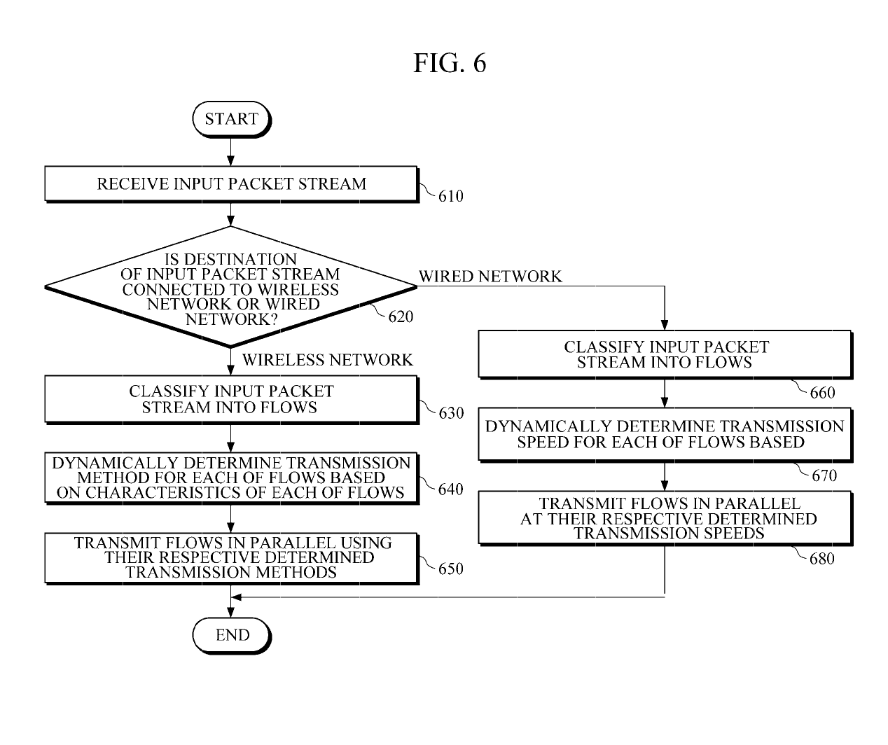

FIG. 6 illustrates another example of a flow transfer method. Referring to FIGS. 3 and 6, the flow transfer apparatus 300 receives an input packet stream (610). The flow transfer apparatus 300 determines whether the destination of the input packet stream is connected thereto via a wired network or a wireless network (620).

If the destination of the input packet stream is connected to the flow transfer apparatus 300 via a wireless network (620), the file transfer apparatus 300 analyzes the input packet stream and thus classifies the input packet stream into a plurality of flows (630). The flow transfer apparatus 300 dynamically determines a transmission method for each of the flows based on the characteristics of each of the flows (640). The flow transfer apparatus 300 transmits the flows in parallel using their respective transmission methods determined in operation 640 (650).

On the other hand, if the destination of the input packet stream is connected to the flow transfer apparatus 300 via a wired network (620), the flow transfer apparatus 300 analyzes the input packet stream and thus classifies the input packet stream into a plurality of flows (660). The flow transfer apparatus 300 dynamically determines a transmission speed for each of the flows based on the characteristics of each of the flows (670). The flow transfer apparatus 300 transmits the flows at their respective transmission speeds determined in operation 670 (680).

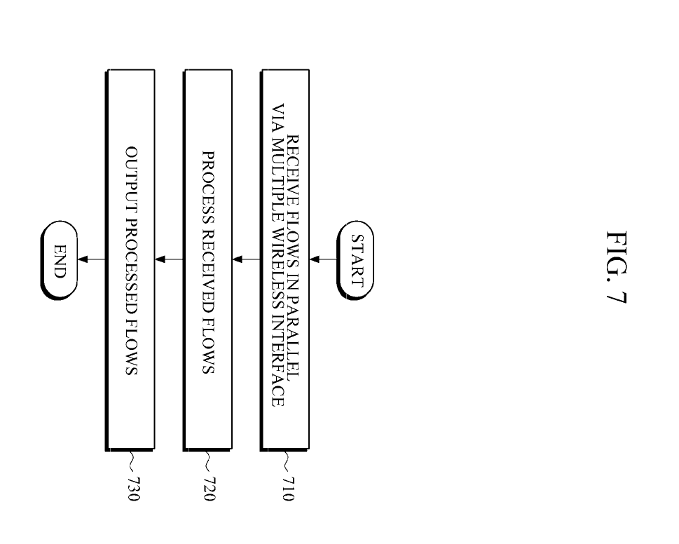

FIG. 7 illustrates an example of a flow processing method. Referring to FIGS. 4 and 7, the terminal apparatus 400 receives a plurality of flows from an access network apparatus, e.g., the flow transfer apparatus 300, via multiple wireless interfaces (610). The flow transfer apparatus 300 processes the received flows according to their characteristics (620). The flow transfer apparatus 300 outputs the processed flows (630).

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A flow transfer method comprising:
analyzing an input packet stream to classify the input packet stream into a plurality of flows;
dynamically determining a transmission method for each of the flows based on the characteristics of each of the flows; and
transmitting the flows in parallel using their respective determined transmission methods.

2. The flow transfer method of claim 1, wherein the characteristics of each of the flows include at least one of the attributes of data included in each of the flows and the attributes of a service provided using each of the flows.

3. The flow transfer method of claim 1, wherein the data attributes include at least one of video data, audio data, best-effort data, weather data, mail data, and gadget data.

4. The flow transfer method of claim 1, wherein the service attributes include at least one of an audio service, a video service, a file transfer service, and a mail service.

5. The flow transfer method of claim 1, wherein the determined transmission methods include at least one of time division multiplexing (TDM), frequency division multiplexing (FDM), orthogonal frequency division multiplexing (OFDM), code division multiplexing (CDM), space division multiplexing (SDM), Wireless Fidelity (WiFi), Third Generation (3G), and Wireless Broadband Internet (WiBro).

6. The flow transfer method of claim 1, wherein the input packet stream has a single destination internet protocol (IP) address and includes a plurality of data attributes.

7. The flow transfer method of claim 1, further comprising:
determining whether a destination of the input packet stream is connected via a wired network;
if the destination of the input packet stream is connected via a wired network, determining a transmission speed for each of the flows based on the characteristics of each of the flows; and
transmitting the flows at their respective determined transmission speeds.

8. The flow transfer method of claim 1, further comprising, if a plurality of flows are received in parallel via a wireless network, generating a packet stream based on the received flows.

9. A flow transfer apparatus comprising:
a flow classification unit configured to analyze an input packet stream and thus to classify the input packet stream into a plurality of flows;
a transmission method determination unit configured to dynamically determine a transmission method for each of the flows based on the characteristics of each of the flows; and
a multiple wireless interface unit configured to transmit the flows in parallel using their respective determined transmission methods.

10. The flow transfer apparatus of claim 9, further comprising a flow processing unit configured to generate a packet stream based on a plurality of flows received in parallel from the multiple wireless interface unit.

11. The flow transfer apparatus of claim 10, further comprising a wired network interface unit configured to communicate with another flow transfer apparatus via a plurality of transmission channels that offer different transmission speeds,
wherein, when the transmission method determination unit determines a transmission speed for each of the flows based on the characteristics of each of the flows, the wired network interface unit transmits the flows via transmission channels corresponding to their respective determined transmission speeds.

12. A flow processing method comprising:
receiving a plurality of flows, via their respective transmission methods, from a flow transfer apparatus connected via a network, the transmission methods being dynamically determined based on the characteristics of the respective flows; and
processing the received flows according to their characteristics.

13. The flow processing method of claim 12, further comprising:
analyzing an input packet stream to classify the input packet stream into a plurality of flows;
dynamically determining a transmission method for each of the flows based on the characteristics of each of the flows; and
transmitting the flows in parallel using their respective determined transmission methods.

14. A terminal apparatus comprising:
a multiple wireless interface unit configured to receive a plurality of flows, via their respective transmission methods, from a flow transfer apparatus connected to the terminal apparatus via a network, the transmission methods being dynamically determined based on the characteristics of the respective flows; and
a flow processing unit configured to process the received flows according to their characteristics.

15. The terminal apparatus of claim 11, further comprising:
a wired interface unit configured to receive a plurality of flows, at their respective transmission speeds, from a flow transfer apparatus connected to the terminal apparatus via a wired Ethernet, the transmission speeds being dynamically determined based on the characteristics of the respective flows,
wherein the flow processing unit classifies and processes the received flows according to their transmission speeds.
